(19) United States
(12) Patent Application Publication
(10) Pub. No.: US 2011/0091027 A1
(43) Pub. Date: Apr. 21, 2011

(54) DISCOVERING AND USING PHONE NUMBER LOCATION INFORMATION

(75) Inventor: Xuan Xing, Redmond, WA (US)

(73) Assignee: MICROSOFT CORPORATION, Redmond, WA (US)

(21) Appl. No.: 12/603,126

(22) Filed: Oct. 21, 2009

(51) Int. Cl. H04M 1/56

(52) U.S. Cl. 379/142.1

(57) ABSTRACT

A telephone number identification system (“TNIS”) and techniques for facilitating telephonic communications (including but not limited to audible communications, text messages, video communications, and multimedia communications) between calling parties and called parties operating electronic devices configured for telephonic communication via telephone numbers are described. The TNIS operates in any client-side electronic device associated with or including a phone, identifying the formats of incoming or outgoing telephone numbers, which are associated with particular countries and include geographic area identifiers and subscriber numbers. The geographic area identifiers are used to identify one or more possible geographic locations associated with the calling or called parties, one or more possible time zones, and/or estimate the cost of telephonic communications between calling and called parties. Calling and called parties are informed of identified information via user interfaces, and decide whether to establish the telephonic communications via telephony networks and/or other communication networks.

### BACKGROUND

Prior to accepting a telephonic communication such as a voice call from a calling party, a called party may wish to learn certain information about the calling party.

Calling number identification (also known as caller ID) is a telephone service, available from many telephony network operators, which transmits a calling party's telephone number and/or identity to a called party's telephone equipment (for example, a phone or separate device) before a call is accepted by the called party.

Despite using a caller ID service, a called party often does not recognize the calling party's telephone number and/or identity, and the called party would benefit from additional information about the calling party and/or the telephonic communication before accepting the communication.

Caller ID also does not address the situation of a calling party desiring to initiate a telephonic communication to a particular telephone number belonging to a called party—the calling party may also benefit from having additional information about the called party and/or the telephonic communication before initiating the communication.

### SUMMARY

A telephone number identification system (“TNIS”) and techniques for facilitating telephonic communications (including but not limited to voice communications and other audible communications, text messages, video communications, and multimedia communications) between calling parties and called parties operating electronic devices configured for telephonic communication via telephone numbers are discussed herein.

In an exemplary implementation, the TNIS includes one or more sets of client-based computer-executable instructions responsive to facilitate, on behalf of called parties and calling parties, the receipt and initiation, respectively, of telephonic communications from/to one or more known or later developed telephony networks, such as wireless networks, public switched telephony networks, or voice-over-IP networks, via the use of telephone numbers. Generally, a telephone number is designated by a particular telephony network for use by a particular party, and has a format associated with a particular country. The format includes, among other possible items, a geographic area identifier, such as a country code and/or an area code, and a subscriber number. In one possible implementation, the TNIS is implemented in a client-side electronic device that is or includes a phone, such as a mobile phone, a landline phone, or a voice-over-IP phone.

The TNIS may additionally include one or more client-based (or may communicate programmatically with one or more server-based) services or applications, including but not limited to: applications or services that accept telephone numbers and identify one or more possible geographic locations associated with the telephone numbers; applications or services that accept geographic locations and/or other information and identify one or more possible time zones associated with the geographic locations; and applications or services that accept telephone numbers and/or other information, and estimate the cost of telephonic communications between calling and called parties.

In one exemplary scenario, for an incoming telephonic communication to a called party electronic device from a telephone number of a particular calling party, the TNIS identifies the format of the telephone number, and based on the format, identifies the country with which the telephone number is associated, and/or geographic area identifier portion of the telephone number. Based on the geographic area identifier, possible geographic locations of the calling party are identified. The called party is informed of the possible geographic locations via a user interface (for example, a graphical user interface), and decides whether to receive the telephonic communication. In one possible implementation, the user interface provides one or more user-selectable visible objects that the called party selects to receive (or reject) incoming telephonic communications.

In another exemplary scenario, for an outgoing telephonic communication from a calling party to a telephone number of a called party, before initiation of the telephonic communication via a telephony network, the TNIS identifies the format of the telephone number, and based on the format, identifies the country with which the telephone number is associated, and/or geographic area identifier of the telephone number. Based on the geographic area identifier, possible time zones in which the called party may be located are identified. The calling party is informed of the possible time zones via a user interface (for example, a graphical user interface), and decides whether to initiate the telephonic communication via the telephony network. In one possible implementation, the user interface provides one or more user-selectable visible objects that the calling party selects initiate telephonic communications via telephony networks.

In further exemplary scenarios, for both incoming and outgoing telephonic communications, estimated costs associated with telephonic communications may be determined based on the geographic area identifiers of telephone numbers having various formats. Called and calling parties may be informed of the estimated costs, and/or one or more alternative communication networks available for communication between the parties, via a user interface. In one possible implementation, the user interface provides one or more user-selectable visible objects that called and calling parties select to initiate communication via alternative communication networks.

This Summary is provided to introduce a selection of concepts in a simplified form. The concepts are further described in the Detailed Description section. Elements or steps other than those described in this Summary are possible, and no element or step is necessarily required. This Summary is not intended to identify key features or essential features of the claimed subject matter, nor is it intended for use as an aid in determining the scope of the claimed subject matter. The claimed subject matter is not limited to implementations that solve any or all disadvantages noted in any part of this document.

### BRIEF DESCRIPTION OF THE DRAWINGS

FIG. 1 is a simplified functional block diagram illustrating an exemplary communication architecture within which aspects of a telephone number identification system (“TNIS”) may be implemented or used.

FIG. 2 is a flowchart of one exemplary method for using aspects of the TNIS shown in FIG. 1 to facilitate telephonic communications between calling parties and called parties.

FIG. 3 is a flowchart of another exemplary method for using aspects of the TNIS shown in FIG. 1 to facilitate telephonic communications between calling parties and called parties.

FIG. 4 is a simplified functional block diagram of an exemplary operating environment in which aspects of the TNIS shown in FIG. 1 and/or the methods shown in FIG. 2 or 3 may be implemented or used.

### DETAILED DESCRIPTION

The telephone number identification system (“TNIS”) and techniques described herein operate to facilitate telephonic communications between calling parties and called parties operating electronic devices configured for telephonic communication via telephone numbers, by providing both calling and called parties with location-based information based on the telephone number(s).

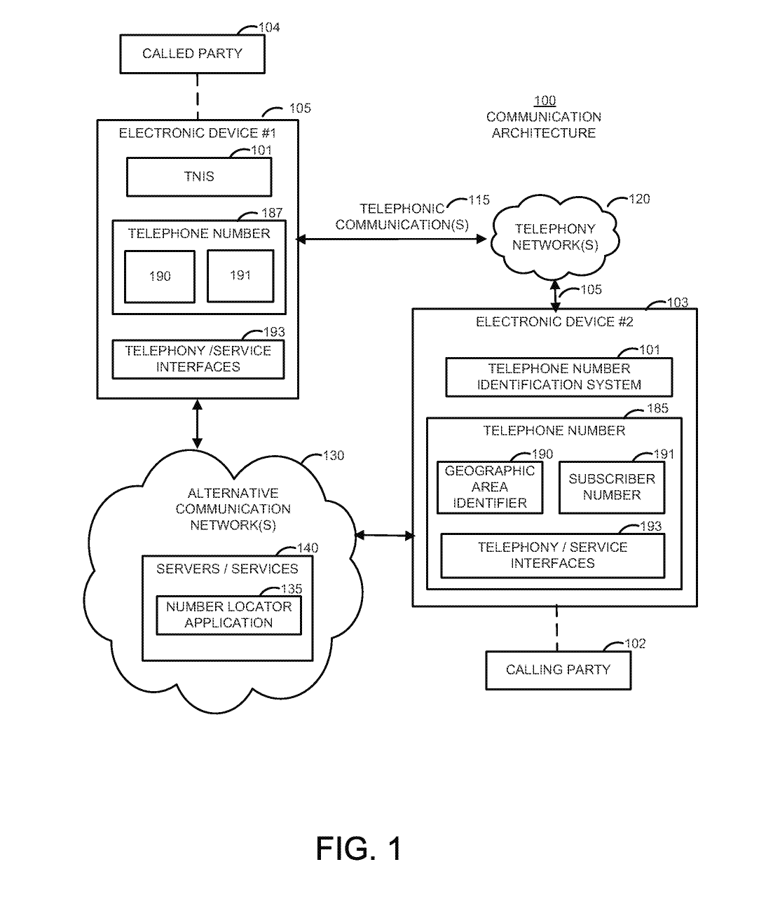

Turning now to the drawings, where like numerals designate like components, FIG. 1 is a simplified functional block diagram illustrating an exemplary communication architecture 100 within which aspects of TNIS 101 are implemented or used. TNIS 101 facilitates telephonic communications 105, including but not limited to voice communications and other audible communications, text messages, video communications, and multimedia communications, via one or more telephony networks 120 (and optionally via one or more alternative communication networks 130) between a calling party 102 and a called party 104, who are authorized to operate electronic devices 103 and 105, respectively. In general, design choices and/or operating environments dictate how and where specific functions of TNIS 101 are implemented. Such functions may be implemented using hardware, software, firmware, or combinations thereof.

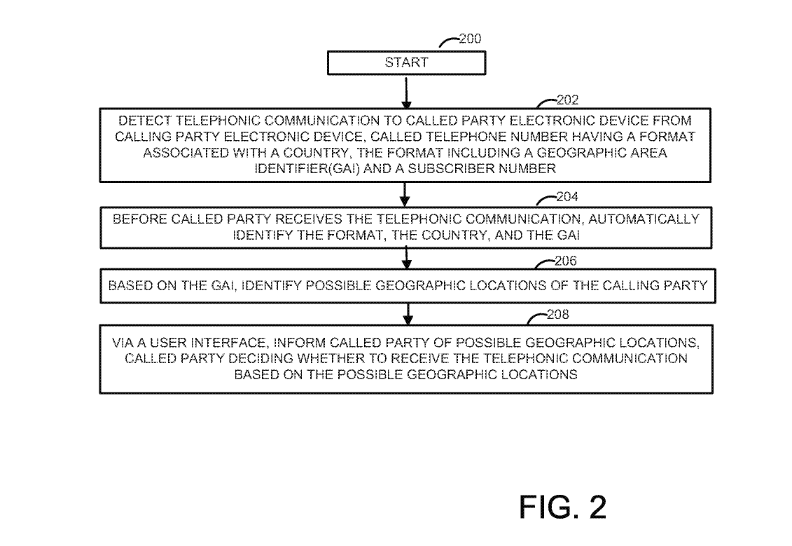

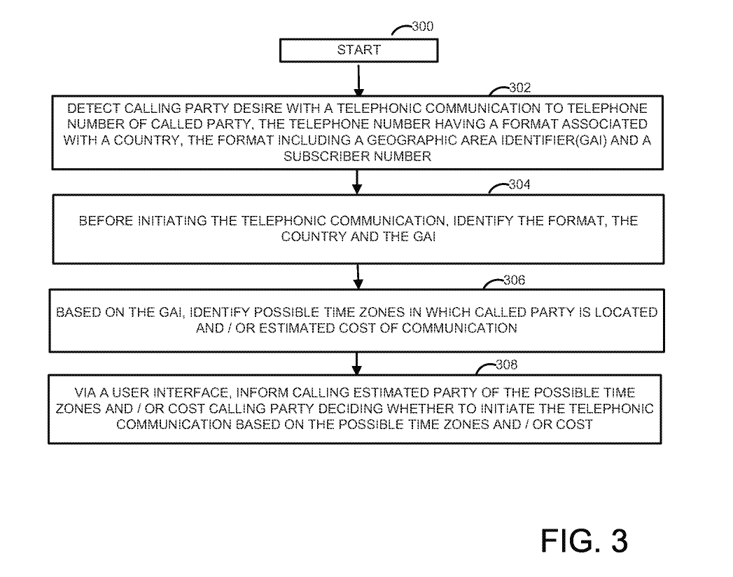

Telephony network(s) 120 represent any existing or future, public or private, wired or wireless, wide-area or local-area, packet-switched or circuit-switched telecommunication infrastructures or technologies. Exemplary telephony networks include: cellular networks, satellite networks, hybrid networks, copper wire networks, voice-over-IP networks, and public switched telephone networks. Alternative communication networks 130 represent any known or later developed communication networks (other than a particular telephony network via which a particular telephonic communication 105 would generally be established), such as the Internet or other local- or wide-area, public or private, wired or wireless, wide-area or local-area, packet-switched or circuit-switched telecommunication infrastructures or technologies. As shown, servers/services 140 residing within alternative communication network(s) host a number locator application 135, which may communicate programmatically with TNIS 101, as discussed further below in connection with FIGS. 2 and 3.

Electronic devices 103 and 105 are any known or later developed electronic devices configured in whole or in part for communication via telephony network(s) 120 and/or alternative communication network(s) 130, including but not limited to mobile phones, landline phones, gaming devices, voice-over-IP phones, personal computers, personal digital assistants, media players, facsimile machines, and the like. Electronic devices 103 and 105 utilize one or more telephony/service interfaces 193 to receive and transmit communications from/to one or more known or later developed telephony network(s) 120, and one or more alternative communication network(s) 130.

In general, each electronic device 103 and 105 is configured for communication via a particular unique telephone number issued by an operator (not shown) of a particular telephony network 120 within a certain country (generally, the country within which the party authorized to operate a particular electronic device resides or does business, and/or in which the issuing telephony network operator does business). As shown, electronic device 103 is configured for communication via telephone number 185, and electronic device 105 is configured for communication via telephone number 187.

Telephone numbers 185 and 187 have formats associated with the certain country within which the party authorized to operate the corresponding electronic device resides or does business, and/or in which the issuing telephony network operator does business—that is, the formats of telephone numbers 185 and 187 generally depend on country-specific conventions. Within a country-specific format, a particular telephone number includes at least a geographic area identifier portion 190 (such as a country code and/or an area code) and a subscriber number portion 191. A particular telephone number may also (but does not necessarily) include other portions, in addition to or as part of geographic area identifier portions 190 or subscriber number portions 191. Examples of other portions include but are not limited to: cost identifier portions (for example, in some countries, certain telephone numbers may be dialed without cost, or different numbers represent different costs); and network identifier portions (for example, in some countries, mobile telephone numbers and landline telephone numbers are accessed using different dialing conventions). Service numbers, such as those used to access fire, ambulance, police, directory information, and other services often offered within a particular country, may have fewer, more, or different portions, and are not discussed in detail herein.

The North American Numbering Plan format is an exemplary format used in the United States, Canada, and some other countries. In accordance with the North American Numbering Plan format, telephony network operators issue telephone numbers in accordance with a dialing plan that includes a 3-digit area code and a 7-digit subscriber number as follows: (AAA) SSS-SSSS, where AAA is the area code, and SSS-SSSS is the subscriber number. In other countries or regions, different formats are used, with area codes (or other geographic area identifiers) and/or subscriber numbers of different (often variable) lengths.

By automatically examining the format of a particular telephone number to ascertain the country with which the telephone number is associated, and based on the country-specific conventions associated therewith, identifying the geographic area identifier portion 190 and the subscriber number portion 191 (along with other desired information), client-based TNIS 101 is able to provide both calling and called parties with useful location information and/or options regarding telephonic communications.

With continuing reference to FIG. 1, FIG. 2 is a flowchart illustrating an exemplary method for using aspects of TNIS 101 to facilitate telephonic communications between a calling party and a called party. In the exemplary method, an incoming telephonic communication, such as a telephonic communication 105, is received at a called party electronic device, such as electronic device 105, from a telephone number of a particular calling party, such as telephone number 185 of calling party 102.

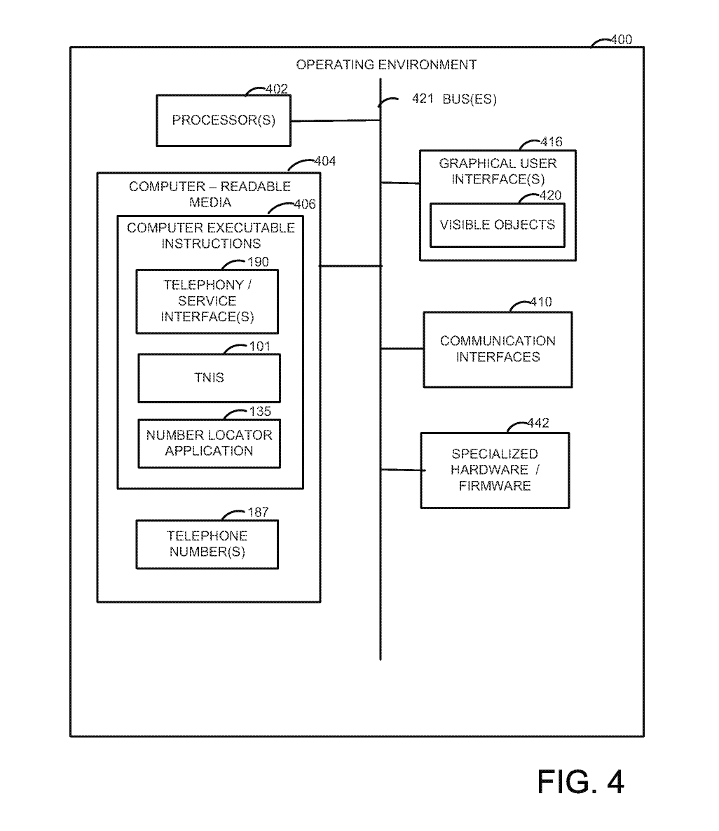

The method illustrated in FIG. 2 may be implemented by computer-executable instructions (such as computer-executable instructions 406, shown and discussed in connection with FIG. 4) that are stored in a computer-readable medium (computer-readable media 404 are also shown and discussed in connection with FIG. 4) and executed by one or more general, multi-purpose, or single-purpose processors (such as processor 402, also shown and discussed in connection with FIG. 4). Unless specifically stated, the methods or steps thereof are not constrained to a particular order or sequence. In addition, some of the methods or steps thereof can occur or be performed concurrently.

The method begins at block 200, and continues at block 202, where the telephonic communication from a calling party electronic device, such as electronic device 103 operated by calling party 102, which is configured for communication via telephone number 185, is detected by TNIS within called party electronic device 105 operated by called party 104. The telephone number has a format associated with a country, and the format includes a geographic area identifier (“GAI”) as well as a subscriber number.

Next, at block 204, before the called party receives the telephonic communication, the format, the country, and the GAI are automatically identified based on the telephone number. As indicated at block 206, based on the GAI, possible geographic locations of the calling party are identified.

In an exemplary implementation, TNIS 101 includes, or is responsive to communicate programmatically with, one or more services or applications (network-side number locator application 135 is shown in FIG. 1) that are responsible for accepting telephone number(s) or identified portions thereof, and based on the format of the particular telephone number(s) or identified portions thereof, provide information regarding the one or more possible geographic locations associated with the telephone number(s).

At block 208, the called party is informed of the possible geographic locations via a user interface, such as a graphical user interface (“GUI”). The called party decides whether to receive the telephonic communication based on the possible geographic locations. In one exemplary implementation, a GUI includes one or more user-selectable visible objects (visible objects 420 are depicted in FIG. 4), which the called party may select to receive the telephonic communication (for example, answer the telephone), if he or she decides to receive the telephonic communication.

Further exemplary scenarios are also possible for an incoming telephonic communication to a called party. For example, via the user interface, the called party may be informed of estimated costs associated with receiving the telephonic communication, and/or alternative communication networks available for communication between the called party and the calling party. The user interface may further provide one or more user-selectable visible objects that the called party may select to act on the information presented via the user interface (for example, initiate communication via an alternative communication network.) As discussed above, TNIS 101 may include, or may be responsive to communicate programmatically with, one or more services or applications (network-side number locator application 135 is shown in FIG. 1) that are responsible for accepting telephone number(s) or identified portions thereof, and based on the format of the particular telephone number(s) or identified portions thereof, provide information including but not limited to: estimates of costs of telephonic communications between calling and called parties via particular telephone number(s), telephony networks, and/or alternative communication networks; and identification of alternative communication networks available to particular parties.

With continuing reference to FIGS. 1 and/or 2, FIG. 3 is a flowchart illustrating another exemplary method for using aspects of TNIS 101 to facilitate telephonic communications between a calling party and a called party. In the exemplary method, a calling party, such as calling party 102, desires to initiate an outgoing telephonic communication, such as a telephonic communication 105, to a telephone number of a called party, such as telephone number 187 of called party 104.

The method illustrated in FIG. 3 may be implemented by computer-executable instructions (such as computer-executable instructions 406, shown and discussed in connection with FIG. 4) that are stored in a computer-readable medium (computer-readable media 404 are also shown and discussed in connection with FIG. 4) and executed by one or more general, multi-purpose, or single-purpose processors (such as processor 402, also shown and discussed in connection with FIG. 4). Unless specifically stated, the methods or steps thereof are not constrained to a particular order or sequence. In addition, some of the methods or steps thereof can occur or be performed concurrently.

The method begins at block 300, and continues at block 302, where the calling party's desire to initiate the telephonic communication to the telephone number of the called party is detected. The telephone number has a format associated with a country, and the format includes a geographic area identifier (“GAI”) as well as a subscriber number. In one exemplary implementation, the calling party may enter the telephone number of the called party into a user interface provided by TNIS 101, or otherwise identify the called party's telephone number to TNIS 101.

As indicated at block 304, before initiation of the telephonic communication via a telephony network, TNIS 101 identifies the format of telephone number 187, and based on the format, identifies the country with which the telephone number is associated, and/or GAI portion 190 of the telephone number.

At block 306, based on the GAI, possible time zones in which the called party may be located are identified. Other information may also be identified based on the GAI, including but not limited to an estimated cost of the telephonic communication, or one or more alternative communication networks available for communication between the parties. In an exemplary implementation, TNIS 101 includes, or is responsive to communicate programmatically with, one or more services or applications (network-side number locator application 135 is shown in FIG. 1) that are responsible for accepting telephone number(s) or identified portions thereof, and based on the format of the particular telephone number(s) or identified portions thereof, provide information including but not limited to: one or more possible geographic locations associated with the telephone number(s); possible time zones associated with the telephone number(s) or GAI(s); identification of alternative communication networks available to particular parties; and estimates of costs of telephonic communications between calling and called parties via particular telephone number(s), telephony networks, and/or alternative communication networks.

As indicated at block 308, the calling party is informed of the possible time zones (and/or other information, such as estimated costs or alternative communication networks) via a user interface, such as a graphical user interface (“GUI”). The calling party decides whether to initiate the telephonic communication based on the information presented via the user interface. In one exemplary implementation, a GUI includes one or more user-selectable visible objects (visible objects 420 are depicted in FIG. 4), which the calling party may select to initiate the telephonic communication (via a telephony network or an alternative communication network) if he or she decides to initiate the telephonic communication.

In this manner, both calling and called parties can benefit from additional information about each other and their telephonic communications. Electronic device manufacturers and/or distributors, telephony network operators, or alternative network operators may generate new business models and/or revenue.

With continuing reference to FIGS. 1-3, FIG. 4 is a simplified functional block diagram of an exemplary operating environment 400, with which aspects of TNIS 101 may be implemented or used. Operating environment 400 is indicative of a wide variety of general-purpose, special-purpose, client- or server-based, stand-alone or networked computing environments. Operating environment 400 may be, for example, a type of computer, such as a personal computer, a workstation, a server, a consumer electronic device (e.g., any electronic device including any known or later developed phone), or any other type of stand-alone or networked computing device or component thereof now known or later developed. Operating environment 400 may also be a distributed computing network or Internet-based service, for example.

One or more components shown in FIG. 4 may be packaged together or separately to implement functions of operating environment 400 (in whole or in part) in a variety of ways. As shown, bus(es) 421 carries data, addresses, control signals and other information within, to, or from computing environment 400 or components thereof.

Communication interface(s) 410 are one or more physical or logical elements that enhance the ability of operating environment 400 to receive information from, or transmit information to, another operating environment (not shown) via a communication medium. Examples of communication media include but are not limited to: wireless or wired signals; computer-readable storage media; computer-executable instructions; communication hardware or firmware; and communication protocols or techniques.

Specialized hardware/firmware 442 represents any hardware or firmware that implements functions of operating environment 400. Examples of specialized hardware/firmware 442 include encoder/decoders (“CODECs”), decrypters, application-specific integrated circuits, secure clocks, and the like.

A processor 402, which may be one or more real or virtual processors, controls functions of operating environment 400 by executing computer-executable instructions 406 (discussed further below).

Computer-readable media 404 represent any number and combination of local or remote components, in any form, now known or later developed, capable of recording, storing, or transmitting computer-readable data, such as instructions 406 (discussed further below) executable by processor 402. In particular, computer-readable media 304 may be, or may include persistent memory or main memory, and may be in the form of: a semiconductor memory (such as a read only memory (“ROM”), any type of programmable ROM (“PROM”), a random access memory (“RAM”), or a flash memory, for example); a magnetic storage device (such as a floppy disk drive, a hard disk drive, a magnetic drum, a magnetic tape, or a magneto-optical disk); an optical storage device (such as any type of compact disk or digital versatile disk); a bubble memory; a cache memory; a core memory; a holographic memory; a memory stick; or any combination thereof. Computer-readable media 404 may also include transmission media and data associated therewith. Examples of transmission media/data include, but are not limited to, data embodied in any form of wireline or wireless transmission, such as packetized or non-packetized data carried by a modulated carrier signal.

Computer-executable instructions 406 represent any signal processing methods or stored instructions that electronically control predetermined operations on data. In general, computer-executable instructions 406 are implemented as software programs according to well-known practices for component-based software development, and encoded in computer-readable media (such as one or more types of computer-readable storage media 404). Software programs may be combined or distributed in various ways.

User interface(s) 416 represent a combination of presentation tools and controls that define the way a user, such as a calling or called party, interacts with operating environment 400. One type of user interface 416 is a graphical user interface (“GUI”), via which user-selectable visible objects 420 are presented, although any known or later developed type of user interface is possible. Presentation tools are used to receive input from, or provide output to, a user. An example of a physical presentation tool is a display such as a monitor device. An example of a logical presentation tool is a data organization technique (for example, a window, a menu, or a layout thereof). Controls facilitate the receipt of input from a user. An example of a physical control is an input device such as a remote control, a display, a mouse, a pen, a stylus, a trackball, a keyboard, a microphone, or a scanning device. An example of a logical control is a data organization technique (for example, a window, a menu, or a layout thereof) via which a user may issue commands. It will be appreciated that the same physical device or logical construct may function as an interface for both inputs to, and outputs from, a user.

Various aspects of an operating environment and an architecture/techniques that are used to implement aspects of TNIS 101 have been described. It will be understood, however, that all of the described elements need not be used, nor must the elements, when used, be present concurrently. Elements described as being computer programs are not limited to implementation by any specific embodiments of computer programs, and rather are processes that convey or transform data, and may generally be implemented by, or executed in, hardware, software, firmware, or any combination thereof.

Although the subject matter herein has been described in language specific to structural features and/or methodological acts, it is also to be understood that the subject matter defined in the claims is not necessarily limited to the specific features or acts described above. Rather, the specific features and acts described above are disclosed as example forms of implementing the claims.

It will further be understood that when one element is indicated as being responsive to another element, the elements may be directly or indirectly coupled. Connections depicted herein may be logical or physical in practice to achieve a coupling or communicative interface between elements. Connections may be implemented, among other ways, as inter-process communications among software processes, or inter-machine communications among networked computers.

The word “exemplary” is used herein to mean serving as an example, instance, or illustration. Any implementation or aspect thereof described herein as “exemplary” is not necessarily to be constructed as preferred or advantageous over other implementations or aspects thereof.

As it is understood that embodiments other than the specific embodiments described above may be devised without departing from the spirit and scope of the appended claims, it is intended that the scope of the subject matter herein will be governed by the following claims.

What is claimed is:

1. A computer-readable storage medium encoded with computer-executable instructions which, when executed by a processor, perform a method for facilitating telephonic communications, the method comprising:
detecting a telephonic communication transmitted to a first electronic device operated by a called party, the telephonic communication initiated by a second electronic device operated by a calling party, the second electronic device configured for telephonic communication via a telephone number having a format associated with a country, the format including at least a geographic area identifier and a subscriber number;
based on the telephonic communication, prior to the called party receiving the telephonic communication via the first electronic device, automatically
identifying the format;
based on the format, identifying the country;
based on the country, identifying the geographic area identifier;
based on the geographic area identifier, identifying one or more possible geographic locations of the calling party; and
via a user interface, informing the called party of the subscriber number and the one or more possible geographic locations of the calling party, the called party deciding whether to receive the telephonic communication via the first electronic device based on the one or more possible locations.

2. The computer-readable storage medium according to claim 1, wherein the geographic area identifier is selected from the group comprising: an area code; and
a country code.

3. The computer-readable storage medium according to claim 1, the method further comprising:
estimating a cost associated with the called parting receiving the telephonic communication via the first electronic device; and
via the user interface, informing the called party of the estimated cost, the called party deciding whether to receive the telephonic communication via the first electronic device based on the estimated cost.

4. The computer-readable storage medium according to claim 2, wherein estimating the cost comprises estimating the cost based on the geographic area identifier.

5. The computer-readable storage medium according to claim 1, wherein the telephonic communication is transmitted via a telephony network, and wherein the method further comprising:
identifying an alternative communication network, other than the telephony network, available for communication between the calling party and the called party; and
via the user interface, informing the called party of the alternative communication network.

6. The computer-readable storage medium according to claim 1, the method further comprising:
identifying an alternative electronic device available for receiving the telephonic communication from the calling party; and
via the user interface, informing the called party of alternative electronic device.

7. The computer-readable storage medium according to claim 1, wherein the user interface comprises a graphical user interface, and wherein the graphical user interface includes a visual object that is selectable by the called party to receive or reject the telephonic communication.

8. The computer-readable storage medium according to claim 1, wherein processor is associated with the first electronic device.

9. The computer-readable storage medium according to claim 1, wherein the first electronic device includes a phone selected from the group comprising: a mobile phone; a landline phone; and a voice-over-IP phone.

10. The computer-readable storage medium according to claim 1, wherein the telephonic communication is selected from the group comprising: a voice message; a text message; and a multimedia message.

11. The computer-readable storage medium according to claim 1, wherein identifying the one or more possible geographic locations of the calling party comprises automatically consulting a network-based service to identify the one or more possible geographic locations.

12. A computer-readable storage medium encoded with computer-executable instructions which, when executed by a processor, perform a method for facilitating telephonic communications, the method comprising:
detecting when a calling party desires to initiate a telephonic communication to a first electronic device operated by a called party, the first electronic device configured for telephonic communication via a telephone number having a format associated with a country, the format including at least a geographic area identifier and a subscriber number, the telephonic communication able to be initiated by a second electronic device operated by the calling party;
prior to the second electronic device initiating the telephonic communication to the called party via a telephony network,
identifying the format;
based on the format, identifying the country;
based on the country, identifying the geographic area identifier;
based on the geographic area identifier, identifying one or more possible time zones in which the called party is located; and
via a user interface, informing the calling party of the one or more possible time zones, the calling party deciding whether to initiate the telephonic communication via the telephony network based on the one or more possible time zones.

13. The computer-readable storage medium according to claim 12, wherein identifying the one or more possible time zones comprises automatically consulting a network-based service to identify the one or more possible time zones.

14. The computer-readable storage medium according to claim 12, wherein the processor is associated with the second electronic device.

15. The computer-readable storage medium according to claim 12, the method further comprising:
identifying an alternative communication network available for communication between the calling party and the called party; and
via the user interface, prior to the second electronic device initiating the telephonic communication to the called party, informing the calling party of the alternative communication network.

16. The computer-readable storage medium according to claim 12, wherein the user interface comprises a graphical user interface, the graphical user interface including a first visual object that is selectable by the calling party to initiate the telephonic communication and a second visual object that is selectable by the calling party to contact the called party via the alternative communication network.

17. An electronic device operable by a calling party to initiate telephonic communications to a called party, the electronic device comprising:
a computer-readable storage medium; and
a processor responsive to the computer-readable storage medium and to one or more computer programs stored in the computer-readable storage medium, the one or more computer programs, when loaded into the processor, operable to perform a method comprising
detecting when the calling party desires to initiate a telephonic communication to a called party via telephone number designated by a telephony network for use by the called party, the telephone number having a format associated with a country, the format including at least a geographic area identifier and a subscriber number,
prior to initiating the telephonic communication,
identifying the format,
based on the format, identifying the country,
based on the country, identifying the geographic area identifier,
based on either the country or the geographic area identifier or both, estimating a cost associated with the telephonic communication, and
via a user interface, informing the calling party of the estimated cost, the calling party deciding whether to initiate the telephonic communication via the telephone number.

18. The electronic device according to claim 17, the method further comprising, prior to initiating the telephonic communication,
identifying an alternative communication network, other than the telephony network, available for communication between the calling party and the called party, and
via the user interface, informing the calling party of the alternative communication network.

19. The electronic device according to claim 18, wherein the user interface comprises a graphical user interface, the graphical user interface including a first visual object that is selectable by the calling party to initiate the telephonic communication and a second visual object that is selectable by the calling party to contact the called party via the alternative communication network.

20. The electronic device according to claim 17, wherein the electronic device includes a phone selected from the group comprising: a mobile phone; a landline phone; and a voice-over-IP phone.
